(19) United States
(12) Patent Application Publication
(10) Pub. No.: US 2005/0132294 A1
(43) Pub. Date: Jun. 16, 2005

(54) Component-based distributed learning management architecture

(76) Inventors: Thomas J. Dinger, Sunnyvale, CA (US); Christopher A. Hyland, Foxboro, MA (US); David B. Millen, Boxborough, MA (US); Charles de Saint-Aignan, Cambridge, MA (US); Fernando Salazar, Arlington, MA (US); Jonathan T. Zempel, Campbell, CA (US)

Correspondence Address: HOFFMAN WARNICK & D'ALESSANDRO, LLC, 3 E-COMM SQUARE, ALBANY, NY, 12207, US

(21) Appl. No.: 10/737,340

(22) Filed: Dec. 16, 2003

(51) Int. Cl. G06F 3/00; G06F 15/16

(52) U.S. Cl. 715/738; 715/501.1; 709/203

(57) ABSTRACT

The present invention provides a distributed learning management architecture that is “componentized” for increased distribution and scalability. Specifically, the present invention provides an architecture in which multiple content servers, delivery servers and/or live session servers can be provided to accommodate multiple geographic locations. The present invention further provides an off-line learning architecture that allows the teachings of the distributed learning management architecture to be implemented on an individual client.

### BACKGROUND OF THE INVENTION

1. Field of the Invention

In general, the present invention provides a component-based distributed learning management architecture. The present invention further provides an off-line learning client for implementing the component-based advantages of the present invention on an individual client.

2. Related Art

As computer technology becomes more pervasive, it has become common for learning environments to be implemented in a computerized environment. For example, today a student can take classes, perform assignments, take exams, etc. from the comfort of his/her personal computer. In many instances, the learning environments are delivered via a network such as the Internet so that the student can participate in the class using a web browser or the like. To this extent, today's generation of learning management systems must be capable of supporting a community of hundreds of thousands of students/learners, several thousand of them concurrently. This scale used to be seen only in the largest corporations and organizations. However, the ubiquity of the Internet has changed this metric. The ability of a learning management system to support thousands of users concurrently is now a necessity. Unfortunately, due to their underlying architectures, the systems built to date are not capable of such capacity.

The various solutions that have been proposed to date such as LearningSpace 5, Docent and Click2Learn all have very apparent drawbacks. Specifically, monolithic applications such as these preclude distributing the system's components, and ultimately reduce scalability. Since these systems provide a single, centralized database, the ability to flexibly distribute the system's components is limited. Further, systems such as these that include content authoring capabilities within the main management component add unnecessary overhead since the management system only uses the results of the authoring process (i.e., the actual content). Furthermore, a proprietary user roster provided in such systems adds management overhead, and allows the management system to be out of synch with the corporate/organization directory.

In view of the foregoing, there exists a need for a distributed learning management architecture. Specifically a need exists for a learning management architecture that is “componentized” for increased distribution and scalability. A further need exists for an off-line learning architecture that allows the teachings of the present invention to be implemented on an individual client.

### SUMMARY OF THE INVENTION

In general, the present invention provides a component-based distributed learning management architecture. Specifically, under the present invention the architecture includes a learning management server for managing an on-line learning environment. Separate from the learning management server is an authoring module that allows educational content to be created. When a student enters the on-line learning environment, one of a set (e.g., one or more) of delivery servers will deliver interface pages to the student's browser. The interface pages display possible selections of educational content available to the student from which the student can select. Any selection made by the student will be received by one of a set of content servers, which will deliver the corresponding educational content to the student in the interface pages. Thereafter, any performance data generated by the student will be routed back to the appropriate delivery server. This delivery server will then periodically send the updated performance data to the learning management server for analysis. This architecture can also support a set of live session servers which provide live learning sessions to the student.

In another embodiment, the present invention provides an off-line learning client architecture. Specifically, a student can download the off-line learning client application to his or her computer and participate in an off-line learning environment. To this extent, the off-line learning client architecture typically includes: a download and synchronization manager for downloading educational content from an on-line learning system and for managing the off-line learning environment on the client; a local delivery server for generating interface pages corresponding to the off-line learning environment on the client; and a local content server for providing the educational content to the student based on requests issued by the student using the interface pages. Any performance data generated by the student based on the educational content is provided to the local delivery server. The next time the off-line learning client is connected to the on-line learning system (the learning management architecture), the download and synchronization manager uploads the performance data to the on-line learning system where it can be analyzed. Thus, the componentized nature of the learning management architecture discussed above can also be provided to individual clients.

A first aspect of the present invention provides a distributed learning management architecture, comprising: an authoring module for creating educational content; a learning management server for managing an on-line learning environment, wherein the learning management module receives the educational content created with the authoring module and provides the educational content to a set of content servers; and a set of delivery servers for delivering a set of interface pages corresponding to the on-line learning environment to students, wherein the set of content servers communicates the educational content to the students based on requests issued by the students using the set of interface pages, and wherein performance data generated by the students based on the educational content is returned to the set of delivery servers.

A second aspect of the present invention provides a component-based distributed learning management architecture, comprising: an authoring module for client-based creation of educational content; a learning management server for managing an on-line learning environment, wherein the learning management module receives the educational content created with the authoring module; a plurality of delivery servers for delivering a set of interface pages corresponding to the on-line learning environment to students; a plurality of content servers for receiving the educational content from the learning management server, and for delivering the educational content to the students based on requests issued by the students using the set of interface pages; and a plurality of live session servers for delivering live learning sessions to the students based on the requests, wherein performance data generated by the students based on the educational content and the live learning sessions is returned to the plurality of delivery servers, and at predefined intervals, the performance data is sent to the learning management server for analysis.

A third aspect of the present invention provides a computerized learning management method, comprising: creating educational content using an authoring module; communicating the educational content created with the authoring module to a learning management server that manages an on-line learning environment; communicating the educational content from the learning management server to a set of content servers; delivering a set of interface pages corresponding to the on-line learning environment to students from a set of delivery servers, where the set of interfaces pages displays possible selections of educational content that are available to the students; and delivering the educational content to the students from the set of content servers based on requests made by the students using the set of interface pages.

A fourth aspect of the present invention provides an off-line learning client architecture, comprising: a download and synchronization manager for downloading educational content from an on-line learning system, and for managing an off-line learning environment on a client; a local delivery server for delivering a set of interface pages corresponding to the off-line learning environment to a student; and a local content server for providing the educational content to the student based on requests issued by the student using the set of interface pages, and wherein performance data generated by the student based on the educational content is provided to the local delivery server.

Therefore, the present invention provides a component-based distributed learning management architecture. The present invention further provides an off-line learning client architecture.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative component-based distributed learning management architecture according to the present invention.

FIG. 2 depicts a more detailed diagram of the learning management server of FIG. 1.

FIG. 3 depicts an illustrative off-line learning client architecture according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience purposes, the Detailed Description of the Invention will have the following sections:
I. Introduction
II. Component-Based Distributed Learning Management Architecture
III. Off-line Learning Client Architecture
   I. Introduction

As indicated above, the present invention provides a component-based distributed learning management architecture. Specifically, under the present invention the architecture includes a learning management server for managing an on-line learning environment. Separate from the learning management server is an authoring module that allows educational content to be created. When a student enters the on-line learning environment, one of a set (e.g., one or more) of delivery servers will deliver interface pages to the student's browser. The interface pages display possible selections of educational content available to the student from which the student can select. Any selection made by the student will be received by one of a set of content servers, which will provide the corresponding educational content to the student in the interface pages. Thereafter, any performance data generated by the student will be routed back to the appropriate delivery server. Then, each delivery server will periodically send updated performance data to the learning management server for analysis. This architecture can also support a set of live session servers which provide live learning sessions to the student.

In another embodiment, the present invention provides an off-line learning client architecture. Specifically, a student can download the off-line learning client application to his or her computer and participate in an off-line learning environment. To this extent, the off-line learning client architecture typically includes: a download and synchronization manager for downloading educational content from an on-line learning system and for managing the off-line learning environment on the client; a delivery server for generating interface pages corresponding to the off-line learning environment on the client; and a content server for providing the educational content to the student based on requests issued by the student using the interface pages. Any performance data generated by the student based on the educational content is provided to the off-line delivery server. The next time the off-line learning client is connected to the on-line learning system (the learning management architecture), the download and synchronization manager uploads the performance data to the on-line learning system. Thus, the componentized nature of the learning management architecture discussed above can be also provided to individual clients.

II. Component-Based Distributed Learning Management Architecture

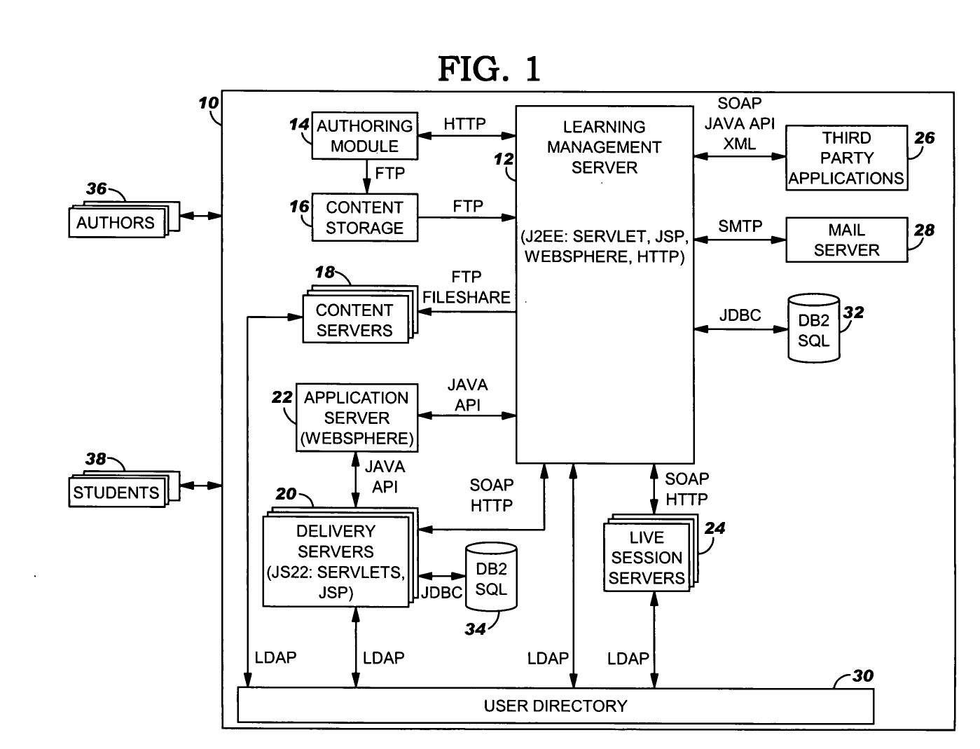

Referring now to FIG. 1, an illustrative distributed learning management architecture 10 according to the present invention is shown. Unlike previous architectures, architecture 10 is component-based. That is, the various servers and modules thereof, are realized as separate elements. This not only provides greater scalability but it also allows various components of architecture 10 to be realized in multiple geographic locations (as will be further described below). It should be understood in advance, that the various communication protocols depicted herein are intended to be illustrative only, and that other variations exist. Moreover, although the present invention is typically realized using the JAVA programming language, other languages could be utilized.

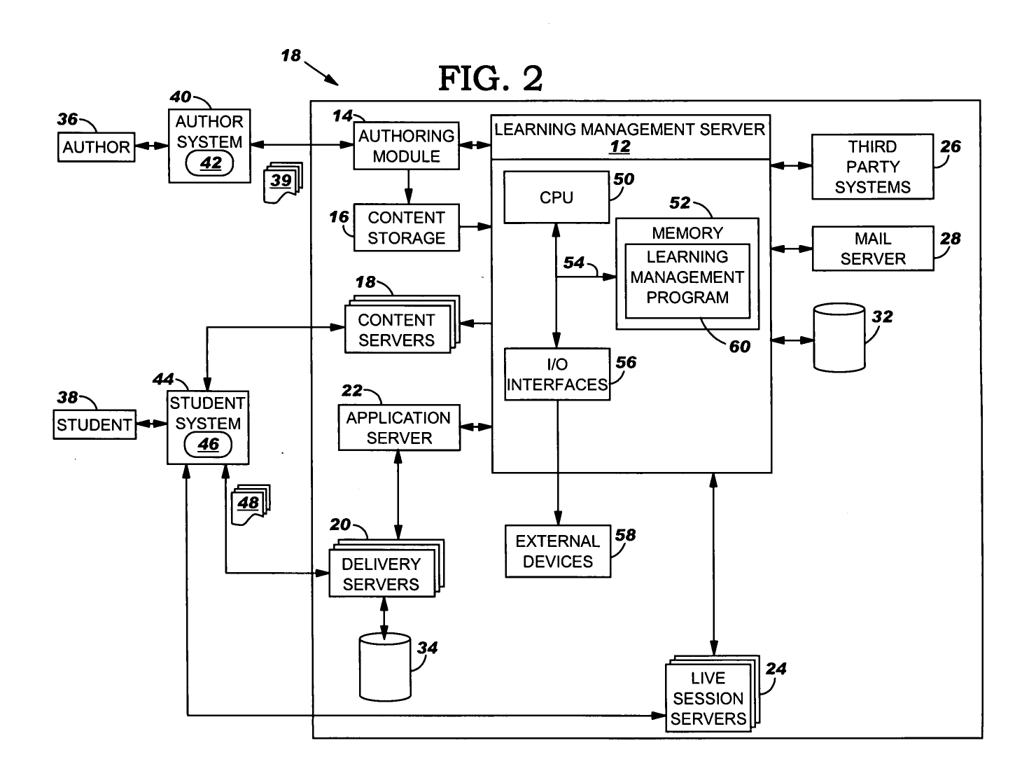

In any event, architecture 10 is generally implemented within a network environment such as over the Internet, a local area network (LAN), a wide area network (WAN), a virtual private network (VPN), etc. Accordingly, as will be described below in conjunction with FIG. 2, authors 36 and students 38 can interface with architecture 10 using separate computerized systems (e.g., clients). Communication between these computerized systems and architecture 10 could occur via a direct hardwired connection (e.g., serial port), or via an addressable connection that may utilize any combination of wireline and/or wireless transmission methods. The computerized systems may utilize conventional network connectivity, such as Token Ring, Ethernet, WiFi or other conventional communications standards. Moreover, connectivity could be provided by conventional TCP/IP sockets-based protocol. In this instance, the computerized systems could utilize an Internet service provider to establish connectivity to architecture 10.

As shown, architecture 10 generally comprises: learning management server 12 for managing an on-line learning environment; authoring module 14 for authors 36 to create educational content for the on-line learning environment; content storage system 16 for storing the educational content; one or more content servers 18 for delivering requested educational content to students 38; one or more delivery servers 20 for delivering a set of interface pages pertaining to the on-line learning environment to students 38; application server 22 on top of which learning management server 12 and delivery servers 20 operate; one or more live sessions servers 24 for delivering live learning sessions to students 38; mail server 28 for communicating notifications to students 38 and other parties; user directory 30 for managing and authenticating the users of architecture 10; and databases 32 and 34 for storing information pertinent to the on-line learning environment such as enrollment, courses, students 38, performance data, instructors, system settings, etc. As further shown, architecture 10 can also support third-party applications 26 (e.g., human resource applications, etc.).

By including a plurality of content servers 18, a plurality of delivery servers 20 and/or a plurality of live session servers 24 (the functions of which will be further described below) as separate elements within architecture 10, greater scalability and distribution is provided. That is, such an embodiment allows architecture 10 to be distributed over multiple organizations or geographic locations. For example, each geographic location could have its own content server 18, delivery server 20 and live session server 58. This was not possible under previous architectures where the content authoring and delivery functions were provided within the main management component.

In any event, at the functional “center” of architecture 10 is learning management server 12. As indicated above, learning management server 12 manages the on-line learning environment. To this extent, learning management server 12 manages, among other things, students 38, courses, enrollment, resources, schedules, reports and system administration. Learning management server 12 also manages the other components of architecture 10. Under the present invention, learning management server 12 can be deployed as a server cluster to handle larger learning loads and can be configured to handle single-sign-on in cooperation with delivery servers 20 and live learning session servers 24.

Assume, for example, that learning management server 12 is currently being used to manage an on-line course relating to Information Technology (IT). To create educational content, one or more authors 36 will interface with authoring module 14, which typically allows for the client-based creation of educational content. To this extent, authoring module 14 could provide interface pages, templates and the like to aid authors 36 in their development. Once the educational content has been created, it will be stored in content storage system 16, for subsequent retrieval by learning management server 12. Once learning management server 12 has performed any needed analysis of the educational content, it can provide the educational content to content servers 18 for eventual delivery to students 38.

When students 38 enroll in the IT course, there may be several offerings of the course to choose from. Each of these offerings could be hosted on a different delivery server 20. Different offerings may occur at different times, have different instructors, or be hosted by different delivery servers. The offering that is “applicable” for student 38 could be determined based on the geographic proximity of the delivery server 20 used to host the offering. For example, if student 38 is located on the East Coast of the United States, and a delivery server 20 that services the East Coast is hosting an offering of the IT course, the student may choose to enroll in that particular offering. Thus, if the IT course is being delivered to students 38 around the country or world, multiple delivery servers 20 might be used to host offerings of the course.

Further assume that a particular student 38 has enrolled in the IT course and wishes to receive the educational content. Student 38 can initially access architecture 10 via learning management server 12, which can perform authentication/approval based on information contained in database 32. Once authenticated, the applicable delivery server 20 will deliver a set (e.g., one or more) of interface pages to student 38. In general, each delivery server 20 is used by learning management server 12 to deliver the interface pages and to receive student 38's performance data. To this extent, learning management server 12 can be configured to support any quantity of delivery servers 20. Any or all of delivery servers 20 can be deployed as a server cluster and can be configured to enable single-sign-on in cooperation with learning management server 12 and live session servers 24.

Regardless, the set of interface pages delivered to the student 38 will typically show only the possible selections of educational content that are available to him/her. Specifically, the student 38 will only be presented with possible selections for courses in which he/she is enrolled. This functionality is enabled in part by accessing database 34, which correlates students 38 with the courses in which they are enrolled. To this extent, database 34 can be considered to have a subset of the information that is in database 32. For example, each delivery server 20 could communicate with its own database 34 that contains this information for the students 38 that the particular delivery server 20 services (e.g., East Coast students). Once the information for the student 38 was ascertained, delivery server 20 would present student 38 with a set of interface pages that list the various educational materials available for the IT course.

When student 38 selects a particular piece of educational content, that request is routed to the applicable content server 18. Similar to learning management server 12 and delivery servers 20, any or all of content servers 18 can be deployed as a server cluster. Still yet, similar to delivery server 20, the “applicable” content server 18 could be determined based on a geographic proximity of student 38. For example, the request from student 38 could be routed to the East Coast content server 18. Once the request is received by the applicable content server 18, the requested educational content (which was previously received by the applicable content server 18 from learning management system 12), would be delivered to student 38.

As further shown, architecture 10 includes one or more live session servers 24, which are configured to deliver live learning sessions to students 38. It could be the case that the on-line learning environment for the IT course is implemented in conjunction with chat or other live discussion technology. If this is the case, a selection for accessing a live learning session could be displayed in the set of interface pages. When student 38 selects the live learning session option, a request for the live learning session would be routed to the applicable live session server 24. Live educational content could then be delivered during such sessions. For example, authors 36 could create content that is to be delivered specifically during a live learning session. In such a case, learning management server 12 will communicate such content to live session servers 24 (e.g., in lieu of communicating it to content servers 18). Similar to learning management server 12 and delivery servers 20, any or all of live session servers 24 can be deployed as a server cluster and can be configured to enable single-sign-on. Further, similar to content server 18 and delivery server 20, the “applicable” live session server 24 could be determined based on a geographic proximity of student 38.

As student 38 generates performance data based on the educational content and/or live learning sessions, such performance data can be communicated to delivery server 20. Periodically (e.g., at predefined time intervals), the performance data will be sent from delivery server 20 to learning management server 12 where it will be processed/analyzed. Using mail server 28, any necessary notifications can be transmitted to student 38 or any instructors. Such messages could include, among other things, enrollment notices, performance data, reports, and general notifications. As such, mail server 28 is intended to represent any type of system capable of facilitating electronic communication (e.g., an electronic mail sever, a discussion or chat-based server, etc.). As further shown in FIG. 2, architecture 10 can support any type of third-party application(s) 26. Examples of such systems include, among other things, a knowledge management server, a human resource system, etc.

Referring to FIG. 2, a more detailed diagram of architecture 10 and learning management server 12 is shown. It should be understood that for clarity purposes, user directory 30 of FIG. 1 has not been depicted in FIG. 2. In any event, as shown, learning management server 12 generally comprises central processing unit (CPU) 50, memory 52, bus 54, input/output (I/O) interfaces 56 and external devices/resources 58. CPU 50 may comprise a single processing unit, or be distributed across one or more processing units in one or more locations, e.g., on a client and computer system. Memory 52 may comprise any known type of data storage and/or transmission media, including magnetic media, optical media, random access memory (RAM), read-only memory (ROM), a data cache, etc. Moreover, similar to CPU 50, memory 52 may reside at a single physical location, comprising one or more types of data storage, or be distributed across a plurality of physical systems in various forms.

I/O interfaces 56 may comprise any system for exchanging information to/from an external source. External devices/resources 58 may comprise any known type of external device, including speakers, a CRT, LCD screen, handheld device, keyboard, mouse, voice recognition system, speech output system, printer, monitor/display, facsimile, pager, etc. Bus 54 provides a communication link between each of the components in learning management server 12 and likewise may comprise any known type of transmission link, including electrical, optical, wireless, etc.

Databases 32 and 34 could include one or more storage devices, such as a magnetic disk drive or an optical disk drive. In another embodiment, databases 32 and 34 include data distributed across, for example, a local area network (LAN), wide area network (WAN) or a storage area network (SAN) (not shown). Furthermore, although not shown, additional components, such as cache memory, communication systems, system software, etc., may be incorporated into learning management server 12. Still yet, although not shown for brevity purposes author system 40 and student system 44 will typically include computerized components similar to learning management server 12.

Shown in memory 52 of learning management server 12 is learning management program 60. In general, learning management program 60 contains program code for performing the functions described herein. For example, learning management program 60 can comprise one or more servlets that manage the on-line learning environment and the other functional elements of architecture 10. To this extent, learning management program 60 can incorporate the teachings of any “learning management program” now known or later developed. Further, it should be appreciated that although not shown, the other functional elements such as authoring module 14, content servers 18, delivery servers 20, live session servers 24, mail servers 28, etc. could also include one or more programs for carrying out their described functions.

In any event, as described above, when an author 36 desires to create educational content for a course (e.g., the IT course), authoring module 14 will deliver a set of “authoring” interface pages 39 to the interface 42 (e.g., a web browser) on author system 40. Author system 40 is intended to represent any type of computerized system (e.g., personal computer, laptop, handheld device, etc.) on which educational content can be created. Once the educational content is created, it will be communicated from authoring module 14 to content storage system 16 where it can be stored until loaded on content server 18 by learning management server 12. When student 38 wishes to receive educational content pursuant to the course, the applicable delivery server 20 will deliver a set of “student” interface pages 48 to interface 46 (e.g., a web browser) on student system 44, which similar to author system 40 is intended to represent any type of computerized system (e.g., personal computer, laptop, handheld device, etc.). As indicated above, set of interface pages 48 delivered to student system 44 are generated based on information contained in database 34 so that only the courses and/or educational material that are available to student 38 will be displayed. For example, student 38 may only be able to select from those courses in which he/she is enrolled. Such possible selections could not only include educational content of the text, video or audio type, but also live learning sessions. For example, set of interface pages 48 could include a link to a live chat or discussion.

When student 38 makes a selection for educational content (e.g., via links, buttons or the like within set of interface pages 48), the request will be received by content server 18. Thereafter, the educational content is delivered to a set of interface pages 48 on student system 44. If student 38 selected a link or the like to a live session, that request will be routed to live session server 24, which will deliver the selected live session. Any performance data generated from the educational content or the live learning sessions will be received by the delivery server 20, and then periodically routed back to learning management server 12 for analysis by learning management program 60.

III. Off-line Learning Client Architecture

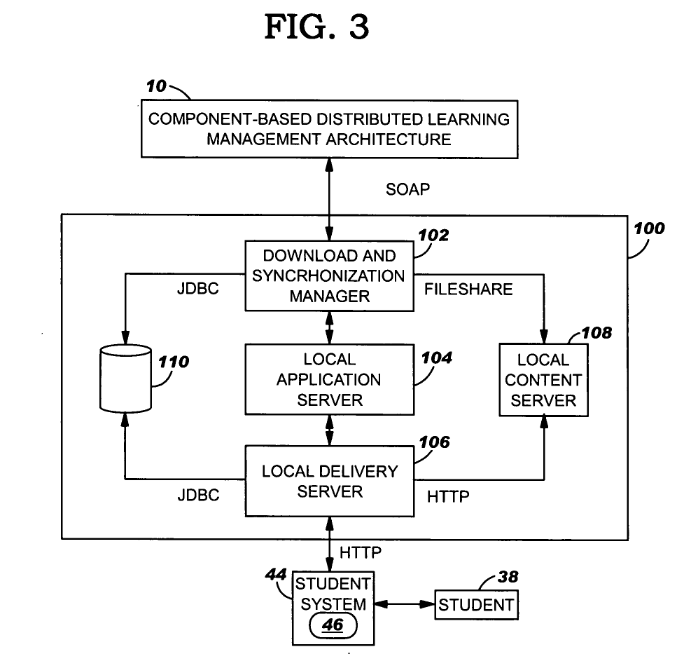

Referring now to FIG. 3, an illustrative off-line learning client architecture 100 according to the present invention is shown. Off-line learning client architecture 100 provides functionality similar to distributed learning management architecture 10, only it is entirely implemented on a client such as student system 44. For example, assume that student 38 was traveling and would be working off-line, but nevertheless wished to participate in the IT course. In this event, student 38 could download off-line learning client architecture 100 to student system 44. As depicted, off-line learning client architecture 100 generally comprises: download and synchronization manager 102; local delivery server 106; local application server 104 for managing local delivery server 106 and download and synchronization manager 102, local content server 108, and local database 110.

Download and synchronization manager 102 is responsible for coordinating communication and exchange (e.g., obtaining educational content) with architecture 10 (i.e., the on-line learning system), and for managing the off-line learning environment. For example, once educational content is downloaded, it can be provided to local content server 108. When student 38 wishes to utilize the educational content, local delivery server 106 will generate and display a set of interface pages in interface 46. Just as with architecture 10, the set of interface pages generated by local delivery server 106 will only contain possible selections of educational content that are available to student 38. To this extent, local delivery server 106 can consult local database 110 to obtain any necessary enrollment information. Such information can be provided to local database 110 via download and synchronization manager 102.

In any event, when student 38 makes a selection, a request for the corresponding educational content will be routed to local content server 108, which will deliver the content to the interface pages. Thereafter, any performance data generated by student will be communicated back to local delivery server 106, and then to download and synchronization manager 102 for communication to architecture 10 the next time a connection between architectures 100 and 10 is established.

It should be understood that the present invention can be realized in hardware, software, or a combination of hardware and software. Any kind of computer system(s)- or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A distributed learning management architecture, comprising:
an authoring module for creating educational content;
a learning management server for managing an on-line learning environment, wherein the learning management module receives the educational content created with the authoring module and provides the educational content to a set of content servers; and
a set of delivery servers for delivering a set of interface pages corresponding to the on-line learning environment to students, wherein the set of content servers communicates the educational content to the students based on requests issued by the students using the set of interface pages, and wherein performance data generated by the students based on the educational content is returned to the set of delivery servers.

2. The architecture of claim 1, further comprising a set of live session servers for delivering live learning sessions to the students based on the requests issued by the students using the interface pages.

3. The architecture of claim 1, wherein the set of content servers comprises a plurality of content servers, wherein the set of delivery servers comprises a plurality of delivery servers, and wherein each of the plurality of content servers corresponds to one of the plurality of delivery servers.

4. The architecture of claim 1, wherein the authoring module provides client-based creation of educational content.

5. The architecture of claim 1, wherein the students communicate with the architecture over a network using browsers, and wherein the set of interface pages are delivered to the browsers.

6. The architecture of claim 1, wherein the learning management server, the set of content servers, the authoring module and the set of delivery servers are implemented as separate elements within the architecture.

7. The architecture of claim 1, wherein the set of interface pages displays possible selections of educational content that are available to the students, wherein the possible selections vary based on identities of the students.

8. The architecture of claim 1, further comprising a content storage module for receiving the educational content from the authoring module, and for providing the educational content to the learning management server.

9. The architecture of claim 1, further comprising a mail server for providing notifications to the students and instructors pertaining to the on-line learning environment.

10. A component-based distributed learning management architecture, comprising:
an authoring module for client-based creation of educational content;
a learning management server for managing an on-line learning environment, wherein the learning management module receives the educational content created with the authoring module;
a plurality of delivery servers for delivering a set of interface pages corresponding to the on-line learning environment to students;
a plurality of content servers for receiving the educational content from the learning management server, and for delivering the educational content to the students based on requests issued by the students using the set of interface pages; and
a plurality of live session servers for delivering live learning sessions to the students based on the requests, wherein performance data generated by the students based on the educational content and the live learning sessions is returned to the plurality of delivery servers, and at predefined intervals, the performance data sent to the learning management server for analysis.

11. The architecture of claim 10, wherein the students communicate with the architecture over a network using browsers, and wherein the set of interface pages are delivered to the browsers.

12. The architecture of claim 10, wherein the learning management server, the plurality of delivery servers, the plurality of content servers and the plurality of live session servers are all implemented as separate elements within the architecture.

13. The architecture of claim 10, wherein the set of interface pages displays possible selections of education content that are available to the students, wherein the possible selections vary based on identities of the students.

14. The architecture of claim 10, further comprising:
a content storage module for receiving the educational content from the authoring module, and for providing the educational content to the learning management server; and
an application server for managing the learning management server and the set of delivery servers.

15. The architecture of claim 10, further comprising a mail server for providing notifications to the students and instructors pertaining to the on-line learning environment.

16. A computerized learning management method, comprising:
creating educational content using an authoring module;
communicating the educational content created with the authoring module to a learning management server that manages an on-line learning environment;
communicating the educational content from the learning management server to a set of content servers;
delivering a set of interface pages corresponding to the on-line learning environment to students from a set of delivery servers, where the set of interfaces pages displays possible selections of educational content that are available to the students; and
delivering the educational content to the students from the set of content servers based on requests made by the students using the set of interface pages.

17. The method of claim 16, further comprising communicating performance data generated by the students based on the educational content to the set of delivery servers, and at predefined intervals, from the set of delivery servers to the learning management server for analysis.

18. The method of claim 16, further comprising delivering live learning sessions to the students based on the requests issued by the students using the interface pages from a set of live session servers.

19. The method of claim 16, wherein the creating step comprises interacting with the authoring module from a client.

20. The method of claim 16, wherein the set of interface pages are delivered to browsers operated by the students.

21. The method of claim 16, further comprising storing the educational content in a content storage module prior to communicating the educational content to the learning management server.

22. The method of claim 16, further transmitting notifications to the students and instructors from the learning management server.

23. An off-line learning client architecture, comprising:
a download and synchronization manager for downloading educational content from an on-line learning system, and for managing an off-line learning environment on a client;
a local delivery server for delivering a set of interface pages corresponding to the off-line learning environment to a student; and
a local content server for providing the educational content to the student based on requests issued by the student using the set of interface pages, and wherein performance data generated by the student based on the educational content is provided to the download and synchronization manager for uploading to the on-line learning system.

24. The architecture of claim 23, wherein the architecture is implemented on a client.

25. The architecture of claim 23, further comprising a local application server for managing the local delivery server and the download and synchronization manager.
